(19) United States
(12) Patent Application Publication
(10) Pub. No.: US 2016/0047482 A1
(43) Pub. Date: Feb. 18, 2016

(54) BIMETALLIC VALVE LIMITATION

(71) Applicant: PIERBURG PUMP TECHNOLOGY GMBH, Neuss (DE)

(72) Inventor: ANDREAS KUHNEKATH, MOENCHENGLADBACH (DE)

(21) Appl. No.: 14/779,571

(22) PCT Filed: Mar. 25, 2013
(86) PCT No.: PCT/EP2013/056283

§ 371 Date: Sep. 24, 2015

(51) Int. Cl. F16K 31/00

(52) U.S. Cl. CPC F16K 31/002

(57) ABSTRACT

A displacement pump for automobiles includes a pump chamber configured to have a lubricant flow therethrough, a check valve configured to control an access to the pump chamber, and a valve travel limiter. The check valve comprises a valve opening and a valve body configured to cover the valve opening. The valve limiter comprises a mechanical temperature element which is configured to increase a valve travel of the valve body as a temperature decreases, and to reduce the travel distance of the valve body as the temperature increases.

### CROSS REFERENCE TO PRIOR APPLICATIONS

This application is a U.S. National Phase application under 35 U.S.C. §371 of International Application No. PCT/EP2013/056283, filed on Mar. 25, 2013. The International Application was published in German on Oct. 2, 2014 as WO 2014/154239 A1 under PCT Article 21(2).

### FIELD

The present invention relates to an automobile displacement pump having a pump chamber accessible via a check valve. The check valve comprises a valve body covering a valve opening.

### BACKGROUND

Such displacement pumps find various applications in the field of automobiles. They convey fluids, generally liquids, in particular liquid coolants or lubricants. The displacement pumps may, however, also be designed as lubricated gas pumps or lubricated vacuum pumps.

Displacement pumps for automobiles are designed for a temperature range from −40° C. to +160° C. Lubricants often show great viscosity differences in this temperature range. Decreasing ambient temperatures are the reason for an increasing viscosity of such lubricants. In order to avoid damage, it is necessary to counteract this increased viscosity by structural measures, i.e., an increase in the valve opening cross section of the check valve so that a sufficiently fast passage of lubricant is provided even at low temperatures of up to −40° C.

The increased viscosity of the lubricant and the large valve opening cross section required therefor, however, lead to long closing times of the check valve. When the pump speed is high and the lubricant is warm, the long closing times cause a large return flow that results in a decreased efficiency.

Various valves to protect displacement pumps against damage have previously been described. JP 571 469 68 describes a valve spring of a bimetal that is adapted to the temperature of the fluid. JP 581 606 75 describes a fluid pressure controller with a disc-like valve spring made of a bimetal. The opening characteristics of the valve body are thereby highly temperature-dependent.

### SUMMARY

An aspect of the present invention is to provide an automobile displacement pump with an enhanced efficiency.

In an embodiment, the present invention provides a displacement pump for automobiles which includes a pump chamber configured to have a lubricant flow therethrough, a check valve configured to control an access to the pump chamber, and a valve travel limiter. The check valve comprises a valve opening and a valve body configured to cover the valve opening. The valve limiter comprises a mechanical temperature element which is configured to increase a valve travel of the valve body as a temperature decreases, and to reduce the travel distance of the valve body as the temperature increases.

### BRIEF DESCRIPTION OF THE DRAWINGS

The present invention is described in greater detail below on the basis of embodiments and of the drawings in which:

FIG. 1 shows a perspective view of an automobile displacement pump with a check valve, and;

FIG. 2 shows an upscale view of a wing of the check valve of FIG. 1.

### DETAILED DESCRIPTION

The present invention provides an automobile displacement pump having a pump chamber. The pump chamber is accessible via a check valve. The check valve comprises a valve body and a valve travel limiter, with the valve body covering and closing the valve opening in its closed position. The valve travel limiter defines the opening position of the valve body at maximum opening and comprises a mechanical temperature element that increases the valve travel as the temperature drops and decreases the valve travel as the temperature rises.

The behavior of the valve body is not essentially influenced by the lubricant temperature, i.e., it is substantially temperature-independent. Via the temperature-dependent valve travel limiter, the opening travel of the valve is set to be as large as possible when the lubricant temperature is low, whereas the opening travel is set to be as small as possible when the lubricant temperature is high.

It is thus provided that, at low lubricant temperatures, despite its high viscosity, the lubricant can flow completely and with relatively low resistance through the large opening cross section or valve opening travel. It is also provided that, when the lubricant temperature is high, the valve travel limiter has a short closing travel and thereby closes faster. The efficiency is thereby improved, especially at high rotary speeds of the pump.

In an embodiment of the present invention, the valve body can, for example, be designed as a leaf spring. This leaf spring is a mechanically simple and at the same time a low-cost embodiment of a valve body. The leaf spring is further elastic or flexible.

In an embodiment of the present invention, the valve travel limiter can, for example, be formed by a bimetal leaf. Contrary to the valve body, the valve travel limiter is primarily rigid. The valve travel limiter is made of a metal with a high linear expansion coefficient as well as of a metal having a low linear expansion coefficient.

When a lubricant with a lower temperature is present at the valve travel limiter, i.e., a lubricant with a higher viscosity, the valve travel limiter is bent more in the opening direction and the maximum opening travel of the check valve is increased. When a lubricant with a higher temperature is present, i.e., a lubricant with a lower viscosity, the valve travel limiter is bent more in the closing direction and the maximum opening travel of the check valve is correspondingly shortened.

The valve travel limiter thus functions both as a travel-limiting component and as a temperature-variable component. It is additionally robust, reliable, simple to assemble, and economical to produce.

In an embodiment of the present invention, the valve travel limiter can, for example, also be designed as a shape-memory material body, in particular of nitinol. With a shape-memory material, an element can be provided in a simple manner which realizes a temperature-dependent opening travel limitation of the valve. The function of the shape-memory material body is based on the so-called two-way (memory) effect. Due to the two-way effect, such shape-memory alloys can remember two shapes—one at a high temperature and one at a lower temperature.

In an embodiment of the present invention, the valve travel limiter can, for example, also be designed as a wax element. A wax element is economical, structurally simple, and can be designed to be failsafe.

In an embodiment of the present invention, the valve body and the valve travel limiter can, for example, each be formed as a tongue that is fixed on the pump chamber wall by one of their tongue ends. The shape of the valve body and of the valve limiter may here be similar to the shape of the valve opening. Both components can thus be fixed by a single fastening element, thereby greatly simplifying assembly.

In an embodiment of the present invention, a single check valve can, for example, be provided. In another embodiment, however, a plurality of check valves can, for example, be arranged side by side on the pump chamber wall.

In an embodiment of the present invention, the check valve may be “double-tongue” shaped in a “butterfly arrangement”, i.e., two wings, namely the tongue-shaped valve travel limiter and the associated valve bodies, extend from the fastening device over the two valve openings of the pump chamber. The two valve travel limiters and the two valve bodies that cover the valve openings are mounted on the pump chamber wall by only a single fastening device. This fastening device may, for example, be provided in the form of a screw. This “butterfly arrangement” has the advantage that, due to the little structural effort, the number of the valve openings can be doubled and thereby an increase in the valve opening cross section is realized.

In an embodiment of the present invention, the check valve can, for example, be assigned to the outlet side. The check valve may additionally be provided on the inlet side, i.e., on the suction side. The latter arrangement is provided for a case in which the pump runs in the reverse as may occur with a mechanical displacement pump when the internal combustion engine runs in the reverse.

In an embodiment of the present invention, the automobile displacement pump can, for example, be an oil-lubricated vacuum pump or a lubricant pump. The fluid to be pumped can, for example, be a lubricating oil, in particular if the aggregate to be supplied is an internal combustion engine to be lubricated. It may also be an oil-lubricated vacuum pump, wherein not only air, but also the lubricant, must be ejected via the pump chamber outlet.

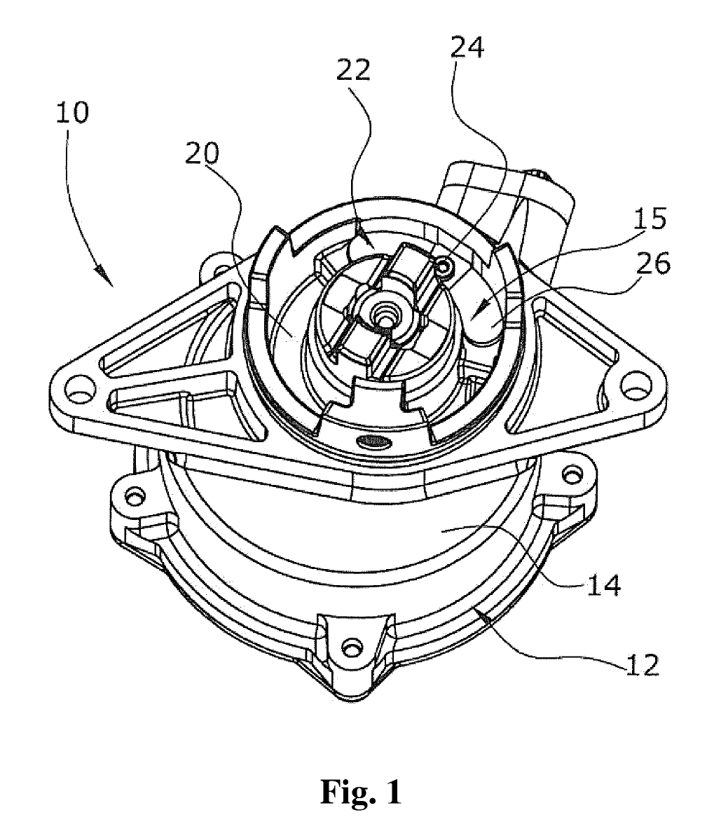

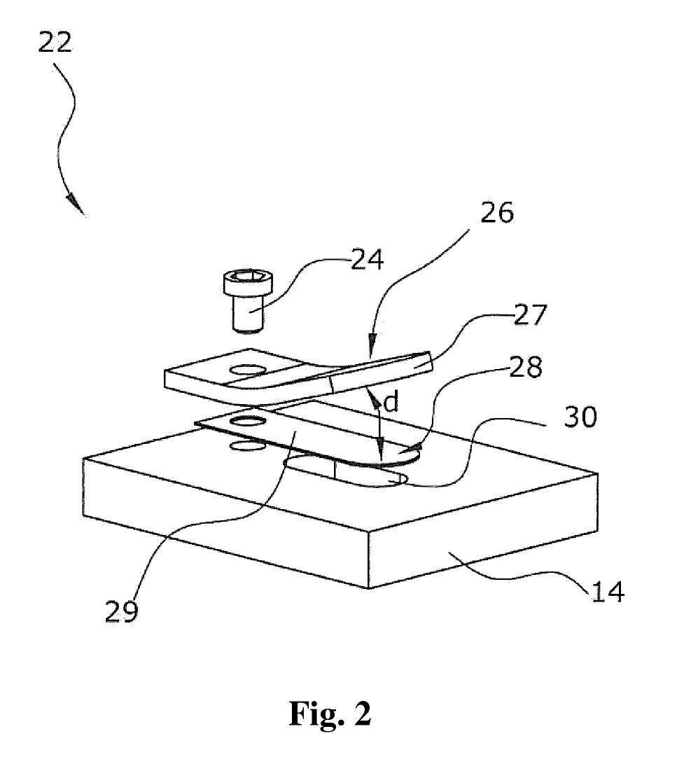

An embodiment of a device according to the present invention is schematically illustrated in FIGS. 1 and 2 and will be described hereafter.

FIG. 1 illustrates a displacement pump 10 for an automobile which, in the present case, is a vacuum pump lubricated with a lubricant. The displacement pump 10 supplies a vacuum of less than 100 mbar for secondary aggregates, for example, a brake booster etc. The vacuum pump 10 is lubricated with a liquid lubricant to increase efficiency and to reduce mechanical wear.

The displacement pump 10 has a pump housing 12. The pump housing 12 encloses a pump chamber 14 with a plurality of pump chamber walls 20. A double-tongued check valve 22 is arranged on one of the two front end pump chamber walls 20. This check valve 22 is provided on the pump chamber wall 14 via a fastening device 24 and opens or closes the two associated valve openings 30. The check valve 22 is assigned to a pump chamber outlet valve 15.

The check valve 22 of the present invention will be described hereunder with reference to FIG. 2 which is an exemplary illustration of a wing of the double-tongued check valve 22. The check valve 22 for the displacement pump 10 shown in FIG. 1 comprises one valve travel limiter 26 and one valve body 28. Both the valve travel limiter 26 and the valve body 28 cover the valve opening 30 provided in the pump chamber wall 20. The valve travel limiter 26 comprises a mechanical temperature element 27 which increases the valve travel d as the temperature falls and reduces the travel as the temperature rises.

The valve body 28 is formed as a leaf spring 29. This leaf spring 29 provides a certain pretension of the valve body 28 in the closing direction. An opening pressure or a limit pressure is defined by this pretension. When the lubricant pressure in the pump chamber 14 exceeds the limit pressure, the check valve 22 is opened by the movement of the valve body 28 in the opening direction. When the pressure of the lubricant increases further, the valve body 28 abuts against the valve travel limiter 26 so as to open the entire valve travel d.

At a low lubricant temperature, the valve travel limiter 26, formed by a temperature element in the form of a bimetallic leaf, is in a rather far open position. When the lubricant temperature surrounding the valve travel limiter 26 rises, the valve travel limiter 26 moves in the closing direction and the valve travel d becomes shorter. The quantity of lubricant flowing through the valve opening 30 is thereby clearly reduced, while at the same time the closing time is shortened.

A particular advantage is that, with regard to the outer shape and the connecting dimensions, the check valve 22 differs only little from a conventional check valve or pressure relief valve so that the present embodiment can be replaced with a conventional valve with little effort.

The present invention is not limited to embodiments described herein; reference should be had to the appended claims.

What is claimed is:

1-10. (canceled)

11. A displacement pump for automobiles, the displacement pump comprising:
a pump chamber configured to have a lubricant flow therethrough;
a check valve configured to control an access to the pump chamber, the check valve comprising a valve opening and a valve body configured to cover the valve opening; and
a valve travel limiter comprising a mechanical temperature element which is configured to increase a valve travel of the valve body as a temperature decreases and to reduce the travel distance of the valve body as the temperature increases.

12. The displacement pump as recited in in claim 11, wherein the valve travel limiter is formed by the mechanical temperature element.

13. The displacement pump as recited in in claim 11, wherein the valve body is a leaf spring.

14. The displacement pump as recited in claim 11, wherein the mechanical temperature element is formed by a bimetallic leaf.

15. The displacement pump as recited in claim 14, wherein the mechanical temperature element is formed by a shape-memory material body.

16. The displacement pump as recited in claim 15, wherein the shape-memory material body is nitinol.

17. The displacement pump as recited in claim 14, wherein the mechanical temperature element comprises a wax element.

18. The displacement pump as recited in claim 11, wherein,
the pump chamber comprises a pump chamber wall, and
the valve body and the valve travel limiter are each formed as a tongue with one end of the tongue being fixed on the pump chamber wall.

19. The displacement pump as recited in claim 11, further comprising a pump chamber outlet valve,
wherein the check valve is assigned to the pump chamber outlet valve.

20. The displacement pump as recited in claim 11, wherein the displacement pump is an oil-lubricated vacuum pump.

21. The displacement pump as recited in claim 11, wherein the displacement pump is a lubricant pump.
